(19) United States
(12) Patent Application Publication
(10) Pub. No.: US 2015/0339198 A1
(43) Pub. Date: Nov. 26, 2015

(54) SEMICONDUCTOR MEMORY DEVICE INCLUDING NONVOLATILE SEMICONDUCTOR MEMORY, CONTROL METHOD OF MEMORY CONTROLLER, AND MEMORY CONTROLLER

(71) Applicant: Kabushiki Kaisha Toshiba, Minato-ku (JP)

(72) Inventors: Ryoichi KATO, Kawasaki (JP); Hironobu Miyamoto, Yokohama (JP); Tomonori Masuo, Kawasaki (JP); Tatsuya Sumiyoshi, Yokosuka (JP); Yuuichirou Gunji, Tachikawa (JP); Jun Shinohara, Kawasaki (JP)

(73) Assignee: Kabushiki Kaisha Toshiba, Minato-ku (JP)

(21) Appl. No.: 14/476,998

(22) Filed: Sep. 4, 2014

(30) Foreign Application Priority Data
May 20, 2014 (JP) 2014-104695

(51) Int. Cl. G06F 11/14; G06F 3/06

(52) U.S. Cl. CPC G06F 11/1451; G06F 3/0679; G06F 3/065; G06F 3/0619

(57) ABSTRACT

In a semiconductor memory device of an embodiment, a backup section writes backup data to a memory. The backup data corresponds to management data which associates identification data of data written to the memory with a write position of the data. A first generator generates update data indicating an updating state when the management data is updated after the backup data is written to the memory. A second generator generates update accumulated data including the update data and past update data which has been generated before the update data and written to the memory. A writer writes the update accumulated data to the memory. A restoration section restores the management data based on the backup data read from the memory and the update accumulated data.

### CROSS-REFERENCE TO RELATED APPLICATIONS

This application is based upon and claims the benefit of priority from Japanese Patent Application No. 2014-104695, filed May 20, 2014, the entire contents of which are incorporated herein by reference.

### FIELD

Embodiments described herein relate generally to a semiconductor memory device including a nonvolatile semiconductor memory, a control method of a memory controller, and the memory controller.

### BACKGROUND

A NAND flash memory is an example of a semiconductor memory. Writing of data to the NAND flash memory is performed per page. In the NAND flash memory, data is deleted per block. A block includes a plurality of pages. In the NAND flash memory, when rewriting of an area in which data has been written is performed, deletion of a rewriting destination area needs to be performed before the rewriting.

Since the NAND flash memory has such a characteristic, data is sequentially written to empty pages. When empty pages are decreased, garbage collection is performed and empty pages are secured.

### BRIEF DESCRIPTION OF THE DRAWINGS

FIG. 1 is a block diagram exemplifying a semiconductor memory device of an embodiment;

FIG. 2 is a flowchart exemplifying write processing of a memory controller of the embodiment;

FIG. 3 is a flowchart exemplifying restoration processing of the memory controller of the embodiment;

FIG. 4 is a block diagram exemplifying a write state of pages and difference pages of the embodiment; and

FIG. 5 is a block diagram conceptually exemplifying the restoration processing of the embodiment.

### DETAILED DESCRIPTION

In general, according to one embodiment, a semiconductor memory device includes a nonvolatile semiconductor memory, a backup section, a first generator, a second generator, a writer, and a restoration section. The backup section writes backup data to the nonvolatile semiconductor memory. The backup data corresponds to management data which associates identification data of data written to the nonvolatile semiconductor memory with a write position of the data. The first generator generates update data indicating an updating state when the management data is updated after the backup data is written to the nonvolatile semiconductor memory. The second generator generates update accumulated data including the update data and past update data which has been generated before the update data and written to the nonvolatile semiconductor memory. The writer writes the update accumulated data to the nonvolatile semiconductor memory. The restoration section restores the management data based on the backup data read from the nonvolatile semiconductor memory and the update accumulated data.

An Embodiment will be described hereinafter with reference to drawings. In a following description, the same reference numerals denote components having nearly the same functions and elements, and a repetitive description thereof will be given if necessary.

In the present embodiment, when management data of a nonvolatile semiconductor memory is updated, update data (hereinafter referred to as a difference log) indicating an updating state is managed. The difference log corresponds to difference data obtained based on the management data acquired before and after the updating. In the present embodiment, backup data corresponding to the management data is written to the nonvolatile semiconductor memory. The management data is restored based on the backup data and the difference log.

The management data has a table form in the present embodiment, but may have another data form such as a list form.

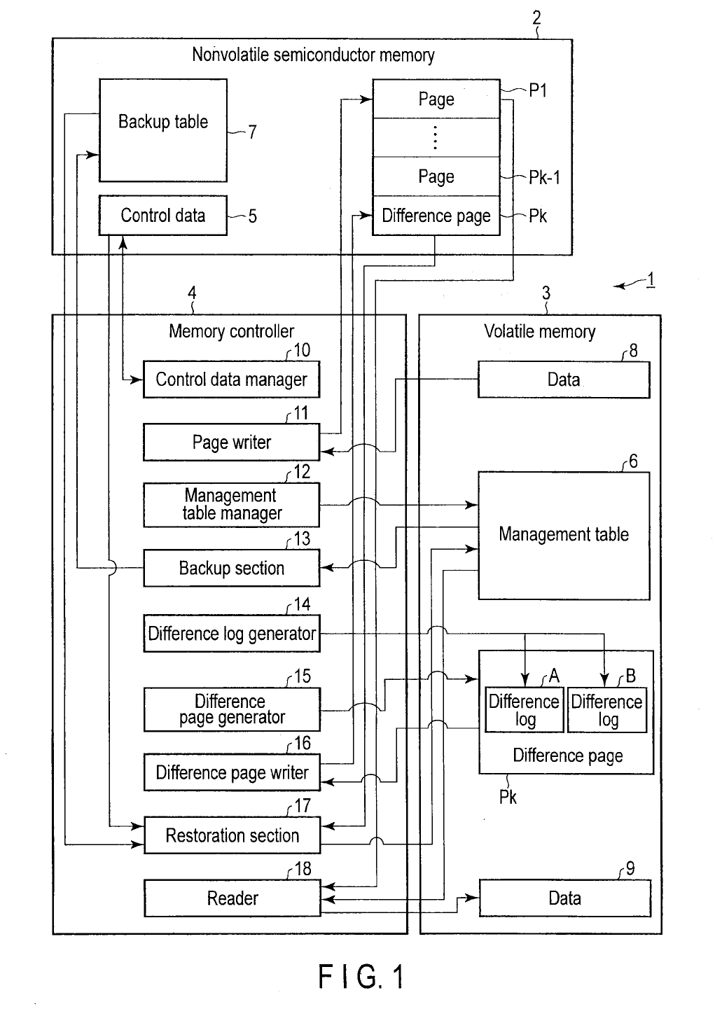

FIG. 1 is a block diagram exemplifying a semiconductor memory device of the present embodiment.

A semiconductor memory device 1 includes a nonvolatile semiconductor memory 2, a volatile memory 3 and memory controller 4. With respect to the memory controller 4, drawings and descriptions of the same components and functions as a general memory controller are omitted.

Although a NAND flash memory, for example, is used as the nonvolatile semiconductor memory 2, a memory, such as a NOR flash memory, a magnetoresistive random access memory (MRAM), a phase change random access memory (PRAM), a resistive random access memory (ReRAM) or a ferromagnetic random access memory (FeRAM), may be used as the nonvolatile semiconductor memory 2.

The nonvolatile semiconductor memory 2 stores control data 5, page data elements (hereinafter referred to as pages) P1 to Pk, which are the write units, and a backup table 7 corresponding to a management table (look-up table) 6. The page Pk is assumed to be a difference page.

It is also assumed that the control data 5 includes, for example, a write time of each of the pages P1 to Pk, a sequential number indicating a write order (sequence) of each of the pages P1 to Pk, valid/invalid data indicating a valid state (data written state) or an invalid state (data deleted state) of each block, an occurrence time of writing to valid blocks, a write time of the backup table 7, and data for specifying the pages P1 to Pk written to the nonvolatile semiconductor memory 2 after latest backup table 7 is written to the nonvolatile semiconductor memory 2.

Information on the pages P1 to Pk of the control data 5 may be managed by a header or a footer of each of the pages P1 to Pk. Furthermore, information on blocks of the control data 5 may be managed by a header or a footer of each block.

The backup table 7 is backup data of the management table 6, and is data that associates identification data elements of respective pages P1 to Pk written to the nonvolatile semiconductor memory 2 with write positions (for example, addresses) of the pages.

The volatile memory 3 stores, for example, data 8 to be written to the nonvolatile semiconductor memory 2, data 9 read from the nonvolatile semiconductor memory 2, the difference page Pk of a predetermined size including at least one difference log, and the latest management table 6.

The memory controller 4 writes the backup table 7 corresponding to the management table 6 to the nonvolatile semiconductor memory 2 such that the write positions of the pages P1 to Pk written to the nonvolatile semiconductor memory 2 can be recognized when power is abnormally turned off and then turned on again.

In order to prevent the nonvolatile semiconductor memory 2 from being exhausted due to highly-frequent repetition of the writing backup table 7 to the nonvolatile semiconductor memory 2, the memory controller 4 writes the backup table 7 to the nonvolatile semiconductor memory 2 on condition that a write event of the backup table 7 occurs. The write event of the backup table 7 occurs, for example, when the semiconductor memory device 1 is normally powered off, when the number of the pages written to the nonvolatile semiconductor memory 2 reaches a predetermined number (i.e., when the number of the difference logs reaches the predetermined number), when a predetermined period has passed, etc. Then, the memory controller 4 restores the management table 6 based on the backup table 7 of the nonvolatile semiconductor memory 2, and difference logs A and B indicating the relationship between the pages P1 to Pk written after the writing of the backup table 7 and the write positions of the pages P1 to Pk, for example, at start processing performed after power is abnormally turned off.

The memory controller 4 includes a control data manager 10, a page writer 11, a management table manager 12, a backup section 13, a difference log generator 14, a difference page generator 15, a difference page writer 16, a restoration section 17, and a reader 18. The memory controller 4 performs reading and writing of various data elements in nonvolatile semiconductor memory 2 and various data elements in volatile memory 3.

The control data manager 10 generates the control data 5 and writes the control data 5 to the nonvolatile semiconductor memory 2. The control data manager 10 also reads the control data 5 from the nonvolatile semiconductor memory 2.

The page writer 11 reads the data 8 from the volatile memory 3, generates the pages P1 to Pk-1 to be the write units, and writes the generated pages P1 to Pk-1 to the nonvolatile semiconductor memory 2.

The management table manager 12 generates and updates the management table 6 which uniquely associates the page identification data elements on the pages P1 to Pk written to the nonvolatile semiconductor memory 2 and the write positions of the pages, and manages the management table 6 in the volatile memory 3.

The backup section 13 reads the management table 6 from the volatile memory 3 and writes the backup table 7 corresponding to the management table 6 to the nonvolatile semiconductor memory 2 on the condition that the write event of the backup table 7 described above occurs.

When the management table 6 of the volatile memory 3 is updated after the backup table 7 is written to the nonvolatile semiconductor memory 2, the difference log generator 14 generates the difference logs A and B corresponding to the management table 6 before updating and the management table 6 after the updating. For example, the difference logs A and B include identification data elements and write positions of the pages P1 to Pk-1 newly written to the nonvolatile semiconductor memory 2.

The difference page generator 15 generates the difference page Pk and writes the difference page Pk to the volatile memory 3. The difference page Pk includes the difference log B, and the past difference log A which has been generated before the difference log B and written to the nonvolatile semiconductor memory 2. The difference page Pk corresponds to update accumulated data. That is, the difference logs A and B which are not reflected on the backup table 7 are accumulated in the difference page Pk. In other words, the difference logs A and B in the difference page Pk are multiplexed. When a total data size of the difference logs A and B exceeds a page size, the oldest difference log is excluded from the difference page Pk and the latest difference log is added. The difference page generator 15 will be hereinafter described more specifically.

When the size of the difference log B exceeds a threshold value smaller than the page size, for example, when the size of the difference log B reaches a threshold value less than or equal to one-half of the page size, the difference page generator 15 generates the difference page Pk including a set of the difference logs A and B obtained after the backup table 7 is updated. In other words, the difference page generator 15 generates the difference page Pk by merging the past difference log A which has been already written to nonvolatile semiconductor memory 2 with the latest difference log B until free space of the difference page Pk is used up.

The past difference log A may be resident in the volatile memory 3, and may be read from the nonvolatile semiconductor memory 2 and used by the difference page generator 15 every time the difference page Pk is generated. When the past difference log A is resident in the volatile memory 3, the past difference log A of a size which becomes equal to the page size by being merged with the latest difference log B is stored in the volatile memory 3. When a size obtained by merging the past difference log A with the latest difference log B exceeds the page size, the oldest past difference log is excluded.

The difference page writer 16 reads the difference page Pk from the volatile memory 3 and writes the difference page Pk to the nonvolatile semiconductor memory 2 on condition that a write event of the difference page Pk occurs.

The write event of the difference page Pk occurs, for example, when a predetermined number of the pages P1 to Pk-1 are written to the nonvolatile semiconductor memory 2, when a predetermined number of pages are written to a predetermined area of the nonvolatile semiconductor memory 2, etc.

After the semiconductor memory device 1 is powered on, the restoration section 17 reads the control data 5 of the nonvolatile semiconductor memory 2, the latest backup table 7 written to the nonvolatile semiconductor memory 2 for the last time, and at least one difference page Pk written to the nonvolatile semiconductor memory 2 after the writing of the latest backup table 7. Then, the restoration section 17 generates the management table 6 updated before the power-off based on the control data 5, the backup table 7 and the difference page Pk, and writes the generated management table 6 to the volatile memory 3. In the present embodiment, the restoration section 17 determines the difference page Pk to be read such that difference logs to be read are not overlapped and the number of difference pages to be read is decreased. Furthermore, when a difference log included in the read difference page Pk has an abnormality of reading, the restoration section 17 reads a difference page written to the nonvolatile semiconductor memory 2 before or after the difference page Pk including the abnormal difference log, and acquires a normal difference log.

The reader 18 reads the pages P1 to Pk-1 from the nonvolatile semiconductor memory 2 based on the management table 6 of the volatile memory 3 and writes the read data 9 to the volatile memory 3.

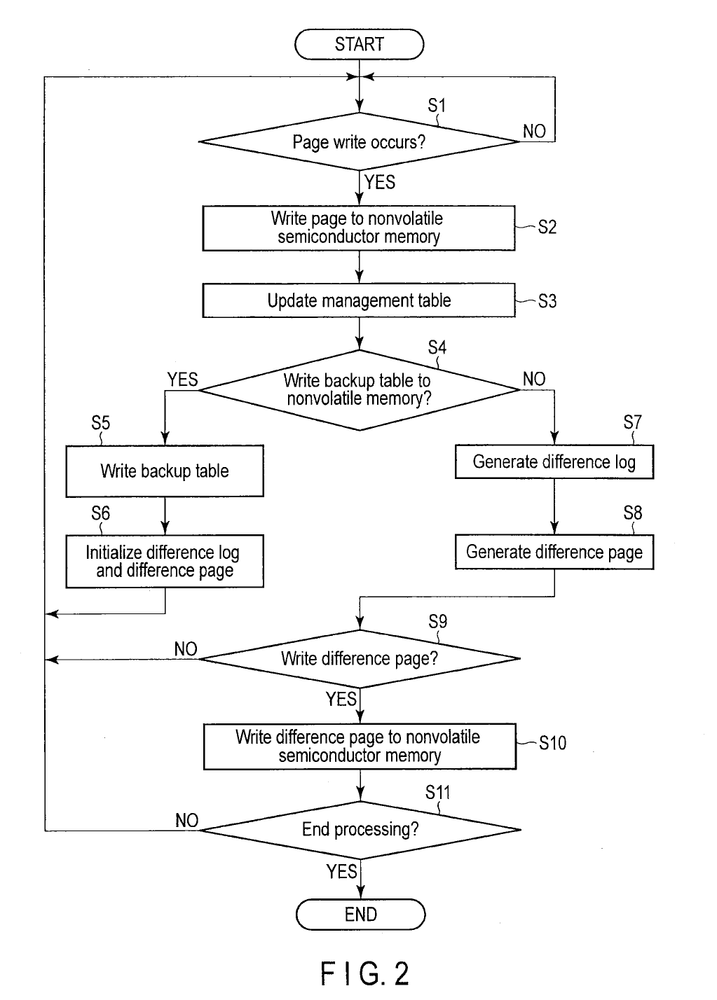

FIG. 2 is a flowchart exemplifying write processing of the memory controller 4 of the present embodiment.

In block S1, the page writer 11 determines whether page write to the nonvolatile semiconductor memory 2 occurs or not.

If page write does not occur (No in S1), the processing repeats block S1.

If page write occurs (Yes in S1), the page writer 11 generates the pages P1 to Pk-1 to be written based on the data 8 of the nonvolatile memory 3, and writes the generated pages P1 to Pk-1 to the nonvolatile semiconductor memory 2 in block S2.

In block S3, the management table manager 12 updates the management table 6 of the volatile memory 3 based on page identification data elements and storage locations of the pages P1 to Pk-1 written to the nonvolatile semiconductor memory 2.

In block S4, the backup section 13 determines whether a condition for writing the backup table 7 to the nonvolatile semiconductor memory 2 is satisfied or not.

If the condition for writing the backup table 7 is satisfied (Yes in S4), the backup section 13 reads the management table 6 of the volatile memory 3 and writes the backup table 7 corresponding to the management table 6 to the nonvolatile semiconductor memory 2 in block S5.

In block S6, the difference log generator 14 and the difference page generator 15 initialize the difference logs and the difference pages of the volatile memory 3. Then, the processing returns to the block S1.

If the condition for writing the backup table 7 is not satisfied (No in S4), the difference log generator 14 generates the difference log B based on the updating state of the management table 6 of the volatile memory 3 in block S7.

In block S8, the difference page generator 15 generates the difference page Pk based on the latest difference log B and the past difference log A which has been generated before the latest difference log B and written to the nonvolatile semiconductor memory 2.

In block S9, the difference page writer 16 determines whether a condition for writing the difference page Pk to the nonvolatile semiconductor memory 2 is satisfied or not.

If the condition for writing the difference page Pk to the nonvolatile semiconductor memory 2 is not satisfied (No in S9), the processing returns to the block S1.

If the condition for writing the difference page Pk to the nonvolatile semiconductor memory 2 is satisfied (Yes in S9), the difference page writer 16 writes the difference page Pk to the nonvolatile semiconductor memory 2 in block S10.

In block S11, the memory controller 4 determines whether the processing should be ended or not.

If the processing is not ended (No in S11), the processing returns to the block S1. If the processing is determined to be ended (Yes in S11), the write processing is completed.

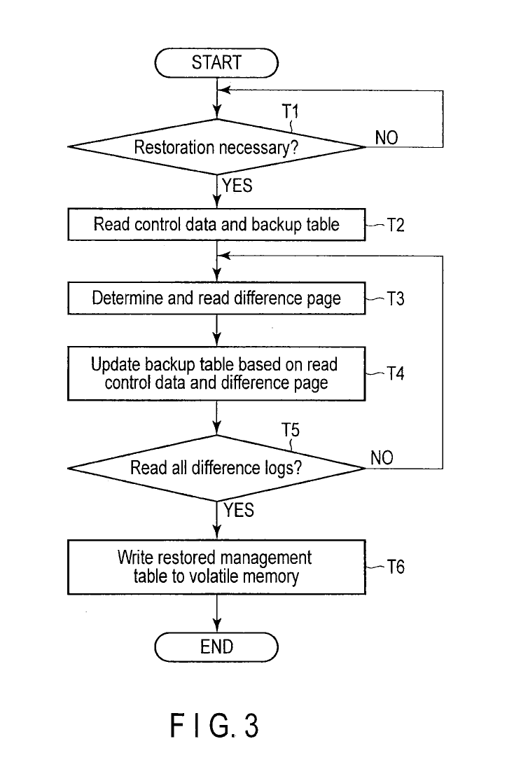

FIG. 3 is a flowchart exemplifying restoration processing of the memory controller 4 of the present embodiment.

In block T1, the restoration section 17 determines whether a condition for restoring the management table 6 of volatile memory 3 is satisfied.

If the condition for restoring the management table 6 of the volatile memory 3 is not satisfied (No in T1), the processing repeats the block T1.

If the condition for restoring the management table 6 of the volatile memory 3 is satisfied (Yes in T1), the restoration section 17 reads the control data 5 and the latest backup table 7 of the nonvolatile semiconductor memory 2 in block T2.

In block T3, the restoration section 17 determines the difference page Pk including the latest difference log B of difference logs which are not read, and as many as possible of difference logs which have been written to the nonvolatile semiconductor memory 2 before the difference log B. Then, the restoration section 17 reads the determined difference page Pk from the nonvolatile semiconductor memory 2.

In block T4, the restoration section 17 updates the backup table 7 based on the read control data 5 and the difference page Pk.

In block T5, the restoration section 17 determines whether all difference logs A and B generated after the backup table 7 is written to the nonvolatile semiconductor memory 2 are read or not.

If all the difference pages are not read (No in T5), the processing returns to the block T3.

If all the difference pages are read (Yes in T5), the restoration section 17 writes the backup table 7 updated in the block T4 to the volatile memory 3 as the restored management table 6 in block T6.

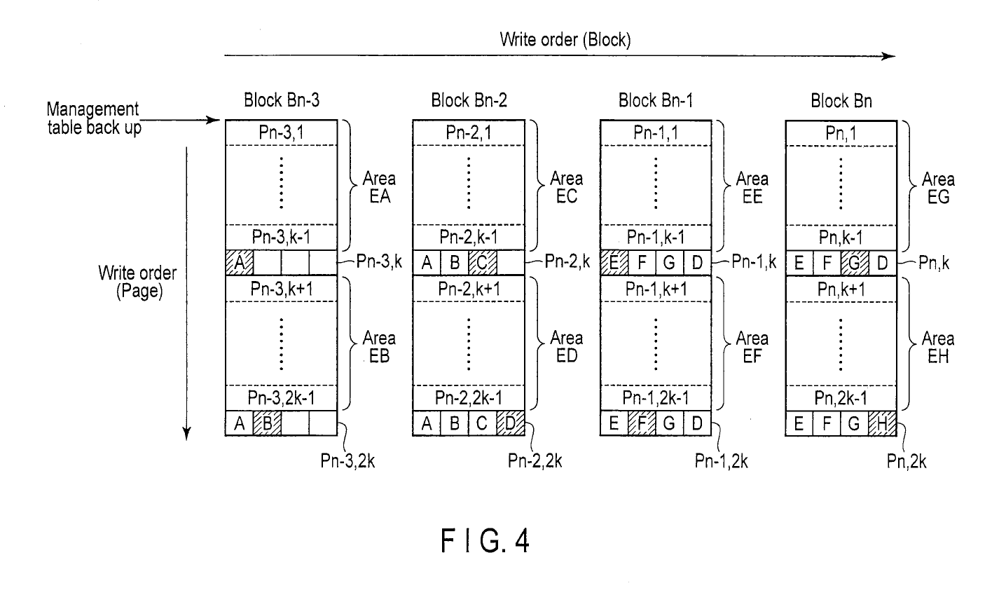

FIG. 4 is a block diagram exemplifying a write state of the pages and the difference pages of the present embodiment. A concrete example of the write processing of the present embodiment will be hereinafter described with reference to FIG. 4.

FIG. 4 exemplifies a case where writing is performed in the order of block Bn-3, block Bn-2, block Bn-1, and block Bn.

FIG. 4 also exemplifies a case where the pages and the difference pages are written in the order from top to bottom in block Bn-3, block Bn-2, block Bn-1, and block Bn. Specifically, the writing is performed in the order from page Pn-3,1 to difference page Pn-3,2k in block Bn-3. The writing is performed in the same manner in block Bn-2, block Bn-1 and block Bn.

FIG. 4 shows a case where the pages of block Bn-3 are sequentially written from the page Pn-3,1 after the latest backup table 7 is written to the nonvolatile semiconductor memory 2.

First, the page writer 11 writes pages Pn-3,1 to Pn-3,k−1 to area EA after the backup table 7 is written to the nonvolatile semiconductor memory 2. When writing, the difference log generator 14 generates the difference log A corresponding to an area EA and writes the difference log A to the volatile memory 3.

The difference page generator 15 generates difference a page Pn-3,k including the difference log A.

The difference page writer 16 writes the difference page Pn-3,k to the nonvolatile semiconductor memory 2.

Next, the page writer 11 writes pages Pn-3,k+1 to Pn-3,2k−1 to an area EB. When writing, the difference log generator 14 generates the difference log B corresponding to the area EB and writes the difference log B to the volatile memory 3.

The difference page generator 15 generates the difference page Pn-3,2k including the difference log B and the past difference log A.

The difference page writer 16 writes the difference page Pn-3,2k to the nonvolatile semiconductor memory 2.

The same write processing as the block Bn-3 described above is also performed to the block Bn-2.

Next, the page writer 11 writes pages Pn-1,1 to Pn-1,k−1 to an area BE. When writing, the difference log generator 14 generates a difference log E corresponding to the area EE and writes the difference log E to the volatile memory 3.

Since a size obtained by merging the difference log E with past difference logs A to D exceeds the page size, the difference page generator 15 deletes the oldest past difference log A and generates a difference page Pn-1,k including the difference log E and the past difference logs B to D.

The difference page writer 16 writes the difference page Pn-1,k to the nonvolatile semiconductor memory 2.

Next, the page writer 11 writes pages Pn-1,k+1 to Pn-1,2k−1 to an area EF. When writing, the difference log generator 14 generates a difference log F corresponding to an area EF and writes the difference log F to the volatile memory 3.

Since a size obtained by merging the difference log F with the past difference logs B to E exceeds the page size, the difference page generator 15 deletes the oldest past difference log B and generates a difference page Pn-1,2k including the difference log F and the past difference logs C to E.

The difference page writer 16 writes the difference page Pn-1,2k to the nonvolatile semiconductor memory 2.

The same write processing as block Bn-1 described above is also performed to block Bn.

After the writing to the block Bn is ended, the backup section 13 writes the backup table 7 to the nonvolatile semiconductor memory 2. Then, the above-described processing is repeated for the other blocks.

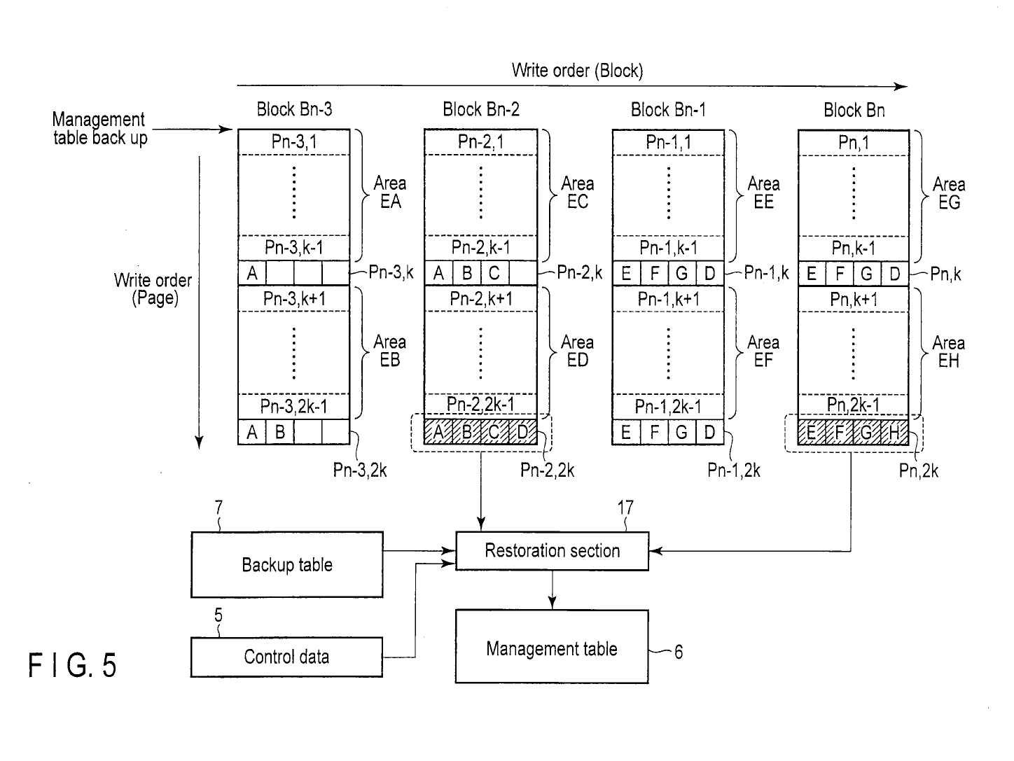

FIG. 5 is a block diagram conceptually exemplifying the restoration processing of the present embodiment. A concrete example of the restoration processing of the present embodiment will be hereinafter described with reference to FIG. 5.

First, the restoration section 17 reads the latest backup table 7 and the control data 5 from the nonvolatile semiconductor memory 2, and further reads the latest difference page Pn,2k which has been last written to the nonvolatile semiconductor memory 2. The latest difference page Pn,2k includes latest difference log H, and plural difference logs E to G (of several areas) which have been generated before the latest difference log H.

The restoration section 17 updates the read latest backup table 7 based on the latest difference page Pn,2k.

Next, the restoration section 17 reads difference page Pn-2,2k including latest difference log D of difference logs A to D which are not included in the latest difference page Pn,2k (i.e., difference logs which are not read). The difference page Pn-2,2k includes the latest difference log D of the difference logs A to D which are not read, and plural difference logs A to C which have been generated before the difference log D. For example, when difference pages are read for the second and subsequent times, the difference page Pn-2,2k including the latest difference log D of the difference logs A to D which are not read and as many as possible of other difference logs A to C which are not read is determined and read.

Next, the restoration section 17 updates the backup table 7 based on the read difference page Pn-2,2k.

Then, the same processing is repeated as necessary and the management table 6 is thereby restored.

When the reading of a difference log has failed at the restoration processing, the restoration section 17 reads a difference page which has been written before or after a difference page including the difference log which has failed in the reading.

When the read difference page includes a difference log corresponding to the difference log which has failed in the reading and the reading of this difference log has been successful, the restoration section 17 updates the backup table 7 by using this difference log.

Furthermore, when the read difference page does not include the difference log which has failed in the reading, the restoration section 17 checks another difference page. The restoration section 17 repeats the same processing until a difference log corresponding to the difference log which has failed in the reading is found.

The restoration processing by the restoration section 17 described above is performed until the backup table 7 is updated by all the difference logs written to the nonvolatile semiconductor memory 2.

When there is a difference log which cannot be read from the nonvolatile semiconductor memory 2 and/or when an invalid power shutdown occurs immediately before a difference log is written, the restoration section 17 reads a log of an area corresponding to the difference log which cannot be read (for example, a log included in a header or a footer of a page arranged in the area, a log included in a header or a footer of a block corresponding to the area, etc.). The restoration section 17 updates the backup table 7 based on the read log and restores the management table 6. Such restoration based on a log attached to a page or a block may be performed before the restoration based on difference logs.

The effect and advantage of the present embodiment will be hereinafter described in comparison with a comparative example.

Since the management table 6 manages a wide area of the nonvolatile semiconductor memory 2, the management table 6 becomes large. Accordingly, degradation of the nonvolatile semiconductor memory 2 may be accelerated if the backup table 7 corresponding to the management table 6 is frequently written to the nonvolatile semiconductor memory 2. The management table 6 is thus assumed to be restored by using both of the following two types of difference logs in the comparative example.

(1) Identification data (for example, logical block addressing [LBA]) included in a header or a footer of a page.

(2) A list-formed log in time series for sequential pages simply written to the nonvolatile semiconductor memory 2.

When the management table 6 is restored, difference logs are first acquired collectively by the list-formed log of (2) in the comparative example. Depending on the timing of power-off, the list-formed log may not exist or the read list-formed log may be broken. In such a case where the list-formed log is not normally read, the log of (1) individually related to a page is acquired in the comparative example.

In the comparative example, if the list of (2) is made sufficiently long, a number of logs can be acquired by a single read operation from the nonvolatile semiconductor memory 2. With respect to a range in which the log of (2) cannot be acquired, however, the number of read operations to acquire the log of (1) is increased. Accordingly, the restoration processing of the management table 6 may require time, and the possibility that the reading of the log of (1) fails may be increased. In this case, since it is difficult to determine which page identification data of a page is broken, the semiconductor memory device 1 is considered to be broken and the operation may be stopped.

In the comparative example, a penalty for a case where the log of (2) does not exist is reduced if the list of the difference log of (2) is shortened. However, since the amount of logs acquired by a single read operation from the nonvolatile semiconductor memory 2 becomes small, the number of read operations of logs of (2) is increased. Accordingly, useless padding data may be written to the nonvolatile semiconductor memory 2 depending on the length of the list.

In contrast, in the present embodiment, when the latest difference log B is written to the nonvolatile semiconductor memory 2, the difference page Pk is generated by merging the latest difference log B with the past difference log A, and the generated difference page Pk is written to the nonvolatile semiconductor memory 2.

Therefore, the increase in the number of write operations to the semiconductor memory device 1 caused by multiplexing the difference logs can be suppressed, and the number of read operations of difference logs in the case where the semiconductor memory device 1 is powered on can be reduced. Furthermore, the restoration processing time of the management table 6 can be shortened, and the situation where a difference log necessary for restoration cannot be acquired can be prevented.

In the present embodiment, when the size of the difference logs reaches a threshold value smaller than the page size, the difference logs are written to the nonvolatile semiconductor memory 2. Therefore, the amount of difference logs which are lost when a semiconductor memory device is abnormally powered off can be suppressed.

In the present embodiment, the past difference log A which has been written to the nonvolatile semiconductor memory 2 is incorporated into free space of the difference page Pk including the latest difference log B, and the plural difference logs A and

B are multiplexed. Therefore, the number of difference pages which need to be read at the restoration processing can be reduced, and the time of the restoration processing can be shortened. When the semiconductor memory device 1 is abnormally powered off, since the multiplexed difference logs A and B are read from the nonvolatile semiconductor memory 2 and used for restoring the management table 6, the number of read operations of difference pages can be suppressed.

In the present embodiment, when the reading of the difference log A included in the difference page Pk from the nonvolatile semiconductor memory 2 has failed, another difference page including the same difference log A is read and the failure of the reading of the difference log A can be recovered. Therefore, the possibility that at least a part of the management table 6 is lost can be reduced.

In the present embodiment, for example, when a difference page or a difference log necessary for updating the backup table 7 is not read from the nonvolatile semiconductor memory 2, for example, a log individually related to a page is acquired from the nonvolatile semiconductor memory 2 and can be used for the restoration processing of the backup table 7.

In the above-described present embodiment, pages P1 to Pk-1 based on data and difference page Pk are not distinguished but sequentially written. However, the pages P1 to Pk-1 based on the data and the difference page Pk may be written to the nonvolatile semiconductor memory 2 while being distinguished from each other. For example, the pages P1 to Pk-1 based on the data and the difference page Pk may be written to different blocks or different areas.

At least a part of functions of the memory controller 4 of the present embodiment may be implemented by a program such as firmware.

At least a part of the functions of the memory controller 4 of the present embodiment may be also implemented by, for example, a system-on-a-chip (SoC).

The nonvolatile semiconductor memory 2 of the present embodiment can be used as, for example, at least a part of a solid-state drive (SSD), and may be used as a cache memory of a hard disk.

The nonvolatile semiconductor memory 2 of the present embodiment may be divided into a plurality of nonvolatile semiconductor memories.

The order of various types of processing described in the present embodiment may be changed as appropriate. For example, the order of the processing of the restoration section 17 may be changed such that control data 5, backup table 7 and all difference pages Pn-2, 2k and Pn, 2k for updating may be first read, the backup table 7 may be then collectively updated based on the difference pages Pn-2, 2k and Pn, 2k for updating, and the management table 6 may be thereby restored.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A semiconductor memory device comprising:
a nonvolatile semiconductor memory;
a backup section which writes backup data to the nonvolatile semiconductor memory, the backup data corresponding to management data which associates identification data of data written to the nonvolatile semiconductor memory with a write position of the data;
a first generator which generates update data indicating an updating state when the management data is updated after the backup data is written to the nonvolatile semiconductor memory;
a second generator which generates update accumulated data including the update data and past update data which has been generated before the update data and written to the nonvolatile semiconductor memory;
a writer which writes the update accumulated data to the nonvolatile semiconductor memory; and
a restoration section which restores the management data based on the backup data read from the nonvolatile semiconductor memory and the update accumulated data.

2. The device of claim 1, wherein
a size of the update accumulated data is a write unit size of the nonvolatile semiconductor memory,
a size of the update data is smaller than the write unit size, and
the second generator adds the past update data to free space of the update accumulated data including the update data when the size of the update data exceeds a threshold value smaller than the write unit size.

3. The device of claim 1, wherein
the writer writes the update accumulated data including latest update data to the nonvolatile semiconductor memory every time a predetermined number of data write operations to the nonvolatile semiconductor memory occur.

4. The device of claim 1, wherein
the second generator deletes oldest update data of the past update data when a size of combination of the update data and the past update data exceeds a predetermined size of the update accumulated data.

5. The device of claim 1, wherein
the restoration section determines first update accumulated data and second update accumulated data to be read from the nonvolatile semiconductor memory such that update data included in the first update accumulated data read from the nonvolatile semiconductor memory and update data included in the second update accumulated data read from the nonvolatile semiconductor memory do not overlap each other.

6. The device of claim 5, wherein
the restoration section reads third update accumulated data written to the nonvolatile semiconductor memory before or after the first update accumulated data when the first update accumulated data includes update data failed in reading.

7. A control method of a memory controller controlling a nonvolatile semiconductor memory, comprising:
writing backup data to the nonvolatile semiconductor memory, the backup data corresponding to management data which associates identification data of data written to the nonvolatile semiconductor memory with a write position of the data;
generating update data indicating an updating state when the management data is updated after the backup data is written to the nonvolatile semiconductor memory;
generating update accumulated data including the update data and past update data which has been generated before the update data and written to the nonvolatile semiconductor memory;
writing the update accumulated data to the nonvolatile semiconductor memory; and
restoring the management data based on the backup data read from the nonvolatile semiconductor memory and the update accumulated data.

8. The method of claim 7, wherein
a size of the update accumulated data is a write unit size of the nonvolatile semiconductor memory,
a size of the update data is smaller than the write unit size, and the method further comprises adding the past update data to free space of the update accumulated data including the update data when the size of the update data exceeds a threshold value smaller than the write unit size.

9. The method of claim 7, further comprising:
writing the update accumulated data including latest update data to the nonvolatile semiconductor memory every time a predetermined number of data write operations to the nonvolatile semiconductor memory occur.

10. The method of claim 7, further comprising:
deleting oldest update data of the past update data when a size of combination of the update data and the past update data exceeds a predetermined size of the update accumulated data.

11. The method of claim 7, further comprising:
determining first update accumulated data and second update accumulated data to be read from the nonvolatile semiconductor memory such that update data included in the first update accumulated data read from the nonvolatile semiconductor memory and update data included in the second update accumulated data read from the nonvolatile semiconductor memory do not overlap each other.

12. The method of claim 11, further comprising:
reading third update accumulated data written to the nonvolatile semiconductor memory before or after the first update accumulated data when the first update accumulated data includes update data failed in reading.

13. A memory controller comprising:
a backup section which writes backup data to a nonvolatile semiconductor memory, the backup data corresponding to management data which associates identification data of data written to the nonvolatile semiconductor memory with a write position of the data;
a first generator which generates update data indicating an updating state when the management data is updated after the backup data is written to the nonvolatile semiconductor memory;
a second generator which generates update accumulated data including the update data and past update data which has been generated before the update data and written to the nonvolatile semiconductor memory;
a writer which writes the update accumulated data to the nonvolatile semiconductor memory; and
a restoration section which restores the management data based on the backup data read from the nonvolatile semiconductor memory and the update accumulated data.

14. The memory controller of claim 13, wherein
a size of the update accumulated data is a write unit size of the nonvolatile semiconductor memory,
a size of the update data is smaller than the write unit size, and
the second generator adds the past update data to free space of the update accumulated data including the update data when the size of the update data exceeds a threshold value smaller than the write unit size.

15. The memory controller of claim 13, wherein
the writer writes the update accumulated data including latest update data to the nonvolatile semiconductor memory every time a predetermined number of data write operations to the nonvolatile semiconductor memory occur.

16. The memory controller of claim 13, wherein
the second generator deletes oldest update data of the past update data when a size of combination of the update data and the past update data exceeds a predetermined size of the update accumulated data.

17. The memory controller of claim 13, wherein
the restoration section determines first update accumulated data and second update accumulated data to be read from the nonvolatile semiconductor memory such that update data included in the first update accumulated data read from the nonvolatile semiconductor memory and update data included in the second update accumulated data read from the nonvolatile semiconductor memory do not overlap each other.

18. The memory controller of claim 17, wherein
the restoration section reads third update accumulated data written to the nonvolatile semiconductor memory before or after the first update accumulated data when the first update accumulated data includes update data failed in reading.
